(19) United States
(12) Patent Application Publication
(10) Pub. No.: US 2023/0228896 A1
(43) Pub. Date: Jul. 20, 2023

(54) ONLINE, REALTIME SCALING TENDENCY MONITOR WITH ADVANCE WARNING AND DATA OUTPUT FOR PROCESS/ANTISCALANT ADJUSTMENTS

(71) Applicant: Halliburton Energy Services, Inc., Houston, TX (US)

(72) Inventor: Tim Underwood, Houston, TX (US)

(21) Appl. No.: 17/579,406

(22) Filed: Jan. 19, 2022

(51) Int. Cl. G01V 1/50; G01V 1/46; G01V 1/38

(52) U.S. Cl. CPC G01V 1/50; G01V 1/46; G01V 1/3808

(57) ABSTRACT

The disclosure addresses overdosing of antiscalants by providing monitoring of scaling tendency to provide advance warning in real time for adjusting antiscalant amounts and other related processes. A method, system, and a scaling tendency monitor are disclosed that provide online monitoring at a well for reducing scaling in production piping, such as production tubing and production lines, while reducing overfeed of antiscalants. The disclosed scaling tendency monitoring gives a real-time warning of increases in scaling tendency, before the scaling actually happens in the production piping. In one example, the scaling tendency monitor includes: (1) conduit, (2) a stresser configured to apply at least one type of scaling stress to tapped produced water flowing through the conduit, and (3) an analyzer configured to determine a change in scaling tendency of the tapped produced water after application of the one or more scaling stress.

### TECHNICAL FIELD

The disclosure relates generally to scaling of pipes and, more specifically, monitoring scaling in real time at hydrocarbon wells.

### BACKGROUND

The production stage is typically the last stage of extracting hydrocarbons from the earth. During the production stage, hydrocarbons, such as oil or gas, flow from subterranean formations to the surface through production tubing that has been cemented in the wellbore. The extracted hydrocarbons can then be transported to refineries for processing.

As the hydrocarbon flows to the surface, scaling can occur in the production tubing. The scaling tendency downhole can change due to various factors, many of which cannot be measured adequately in real-time. As such, a predicted scaling tendency (and scale inhibition chemical dosage) is often determined based on an analysis of the water flowing with the hydrocarbons. For example, periodic analysis of the water's analytes are used for theoretical calculations predicting scaling tendency. Since these types of analysis cannot give completely accurate and timely changes in scaling tendency, scale inhibition chemical dosages are estimated, and applied at levels which should be high enough to cover periodic peaks in scaling tendencies (i.e., dosage insurance). This dosing insurance strategy can lead to costly, long-term overdosing of antiscalants when the scaling tendencies are lower, or risks costly scaling situations when sufficient “insurance” dosage required to cover spikes in scaling tendency is not applied.

### SUMMARY

In one aspect, the disclosure a scaling tendency monitor. In one example, the scaling tendency monitor includes: (1) conduit, (2) a stresser configured to apply at least one type of scaling stress to tapped produced water flowing through the conduit, and (3) an analyzer configured to determine a change in scaling tendency of the tapped produced water after application of the one or more scaling stress.

In another aspect, the disclosure provides a method of monitoring a change in scaling tendency for a wellbore. In one aspect, the method includes: (1) receiving a tapped produced water, (2) stressing, while flowing through a conduit, the tapped produced water, and (3) determining a change in scaling tendency of the tapped produced water after the stressing

In yet another aspect, the disclosure provides a scaling tendency monitoring system for a well. In one example, the monitoring system includes: (1) a tap line connected to a production line associated with the well, and (2) a scaling tendency monitor that has a conduit connected to the tap line, a stresser configured to apply at least one type of scaling stress to tapped produced water flowing through the tap line and the conduit, and an analyzer configured determine a scaling tendency of the tapped produced water after application of the one or more scaling stress.

### BRIEF DESCRIPTION

Reference is now made to the following descriptions taken in conjunction with the accompanying drawings, in which:

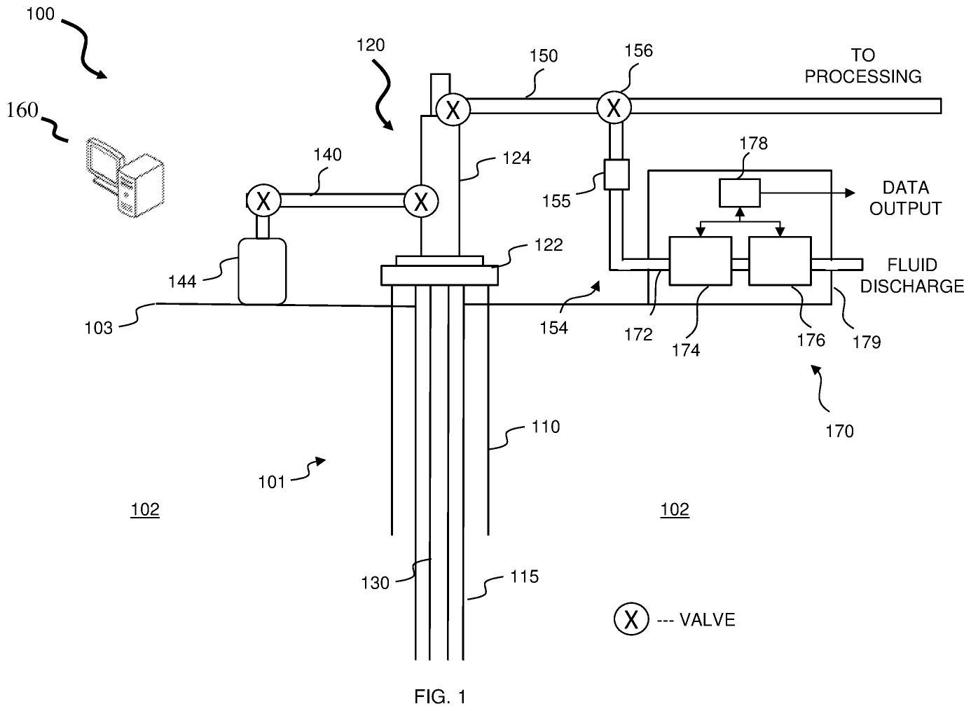

FIG. 1 illustrates a diagram of an example of a completed well configured to extract hydrocarbons from subterranean formations according to the principles of the disclosure;

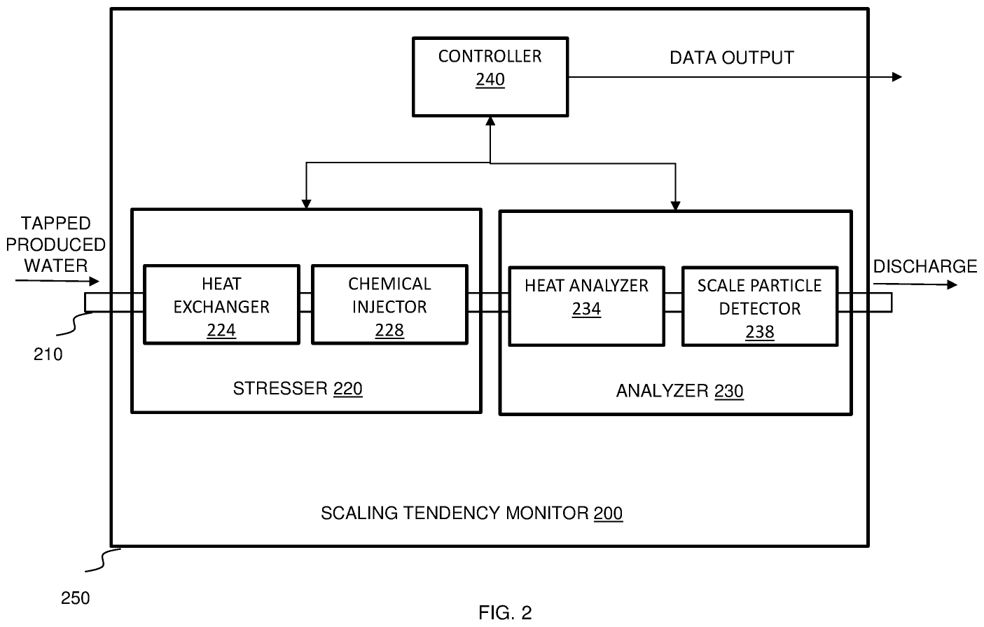

FIG. 2 illustrates a block diagram of an example of a scaling tendency monitor constructed according to the principles of the disclosure;

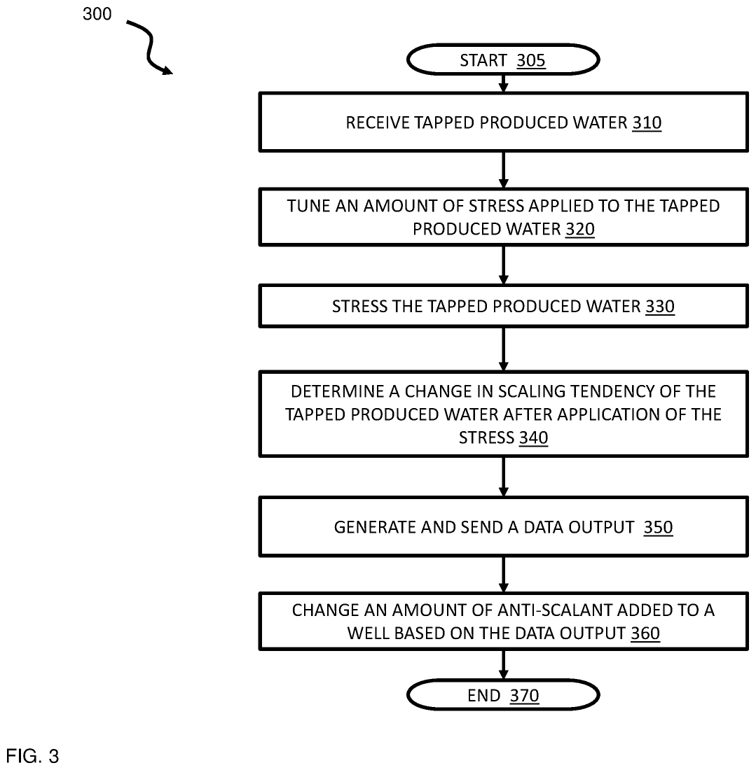

FIG. 3 illustrates a flow diagram of an example of a method of monitoring a change in scaling tendency carried out according to the principles of the disclosure; and

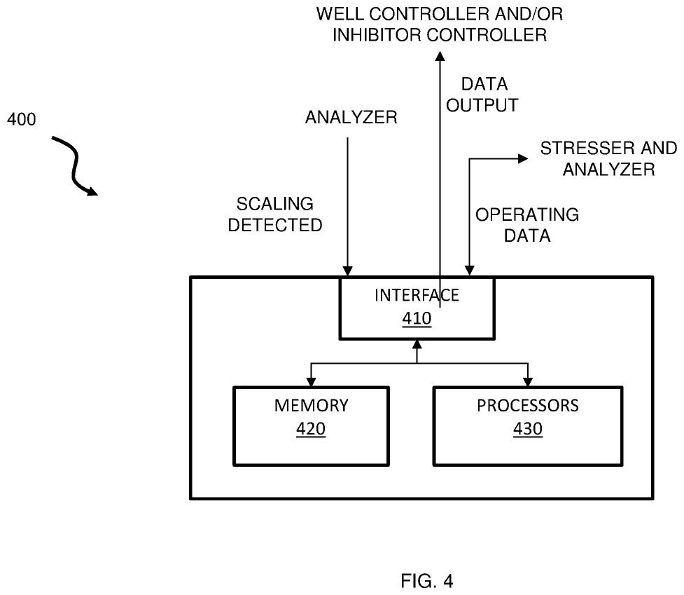

FIG. 4 illustrates a block diagram of an example of a controller of a scaling tendency monitor constructed according to the principles of the disclosure.

### DETAILED DESCRIPTION

In hydrocarbon production processes, once a wellbore has been completed, e.g, drilled and fractured, operational testing and monitoring are performed to optimize the wellbore production. As noted above, one condition that is monitored is scaling of material used in a producing well, such as production tubing. Existing methods for monitoring and ideally preventing scaling can lead to overdosing of antiscalants.

The disclosure addresses the overdosing problem by providing monitoring of scaling tendency to provide advance warning and data output in real time for adjusting antiscalant amounts and other related processes. A method, system, and scaling tendency monitor are disclosed that provide online monitoring at a wellbore for reducing scaling in production piping, such as production tubing and production lines, while reducing overfeed of antiscalants. The disclosed scaling tendency monitoring gives a real-time warning of increases in scaling tendency, before the scaling actually happens in the production piping. The real-time warnings are achieved without the time consuming and cumbersome sampling, analysis, and theoretical calculations of scaling tendency which are used in legacy methods for trying to control scale with predicted inhibitor dosages.

The disclosed scaling tendency monitoring can be used with a well which has been known to have occasional periods of scaling, which need very high dosages of scale inhibitor. For example, fluids including gas, dirt, sand, water, oil, or a combination of any of these can be flowing fine in the well with a certain level of antiscalant being added, but suddenly, without the well operators being able to analyze or determine what scaling parameters have changed, scale forms. In this situation, a high level of antiscalant would be run indefinitely, to cover the surprise scaling events.

The disclosed scaling tendency monitor can be installed at a well to alleviate these scaling events by increasing the antiscalant feed rate, when scaling tendency increases. The scaling tendency monitor can be installed on a small side-stream of a production line, such as a main production line, to receive produced water flowing through the production line. The tapped produced water flowing through the scaling tendency monitor is stressed to an extent near-scale formation. Produced water is water that is brought to the surface with the extracted hydrocarbon through downhole production tubing. Tapped produced water is a portion of the produced water that is diverted from piping, such as a production line. The stress can be a temperature (heat) that is applied or chemical stress (a scalant) that is added to the tapped produced water depending on the type of scaling for the well. The type of scaling for a particular well can be based on historical data for that particular well or similar wells that are proximate that well. Using heat as an example for inverse solubility scales, the tapped produced water flowing through the scaling tendency monitor is heated to an extent closer to its scale formation temperature. The scale formation temperature can be determined using the scaling tendency monitor. For example, the scaling tendency monitor can be used to form scales and a temperature of when the scale forming occurred is noted. The temperature at the scaling tendency monitor can then be reduced below the scale formation temperature. In some examples the temperature reduction can be between five to ten percent. Using numbers as an example, the scale formation temperature (when scales form in the scaling tendency monitor) can be 280 degrees and the temperature can be reduced to 255 degrees. Similarly, the scaling tendency monitor can also be tuned by adding a scalant in the scaling tendency monitor to establish when scaling occurs and then reduce the amount of scalant to a lower level for monitoring. For example, results of scaling can occur at 10 mils a minute and the amount of scaling can be reduced to 7 mils a minute for monitoring.

Thus, if the produced water has a natural increase in scaling tendency downhole (which can happen due to many complex and many times undetectable factors), the tapped produced water in the scaling tendency monitor will form scale before the actual main produced water. In other words, when natural scale forming conditions increase in the main produced water, the tapped produced water in the scaling tendency monitor will begin to scale sooner than the main produced water. The scaling tendency monitor can sense this scaling in the stressed sidestream, which indicates a change in scaling tendency, and provide a data output as an early warning. Sensing of the scaling can depend on the type of scaling stress that is applied to the tapped produced water. When heat stress is used, heat transfer analysis can be used to determine scaling. When chemical stress is used, a scale particle detector can be used to determine scaling. The data output can be a digital output and can be sent before actual downhole scaling occurs. The output data can be used for sending out alarms and adjusting scale inhibitor dosages in real time as fluid flows uphole through the scaling tendency monitor and scaling is detected.

Regardless the type of scaling stress and the type of analysis, the scale inhibitor dosages can be adjusted in real time by controlling the output of scale inhibitor metering pumps as scaling tendency increases or decreases. As such, the scaling tendency monitoring can be used for automated inhibitor adjustments and online monitoring of scaling tendency. Accordingly, the disclosure provides a robust method and equipment for real-time monitoring of scaling tendency changes in production lines and downhole in production tubing. The data output generated by the real-time monitoring can be provided to a user for manual intervention and can also be used to initiate automated changes in scale inhibitor dosages.

FIG. 1 illustrates a diagram of an example of a completed well 100 configured to extract hydrocarbons from subterranean formations according to the principles of the disclosure. The well 100 is a production well that extracts a hydrocarbon, such as oil or gas, from wellbore 101 that extends into the earth 102. FIG. 1 depicts an onshore operation. Those skilled in the art will understand that the disclosure is equally well suited for use in offshore operations or onshore operations over a body of water. Additionally, while wellbore 101 is a vertical well one skilled in the art will understand that the disclosure is applicable to other wells that include one or more horizontal sections.

The well 100 includes surface casing 110 that is cemented in place and a casing string 115 that is cemented in the wellbore 101 inside of the surface casing 110. The surface casing 110 extends out of the wellbore 101 and supports well head equipment 120 at the surface 103. Production tubing 130 is suspended within the casing string 115 from the well head equipment 120. Hydrocarbons are extracted from the earth 102 to the well head equipment 120 via the production tubing 130. Produced water is typically included with the extracted hydrocarbon.

The well head equipment 120 includes a well head 122 and a tree 124 on top of the well head 122. The tree 124, often referred to as a Christmas tree, provides flow control for the hydrocarbon that is received flowing from the production tubing 130. The tree 124 is a vertical assembly of valves with gauges and chokes (not shown) that allow for adjustments in flow control of the hydrocarbon and injections into the wellbore 101 to stimulate production. An example of a valve is denoted in the legend in FIG. 1. The tree 124 can include multiple valves that control various taps. In FIG. 1, only two lines are shown connected to the tree 124, an inhibitor line 140 and a production line 150.

The inhibitor line 140 is coupled to inhibitor metering pumps 144 that provide antiscalant to the wellbore 101 to prevent scaling within the production tubing 130 and the production line 150. Operation of the inhibitor metering pumps 144 can be controlled by a well site controller 160, which can be communicatively coupled to inhibitor metering pumps 144 and other components at the well 100. Well site controller 160 includes a processor and a memory and is configured to direct operation of the well 100.

The production line 150 is a main production line that receives the extracted hydrocarbon and delivers the hydrocarbon for further processing. The production line 150 can be, for example, coupled to storage tanks that stores the hydrocarbon for future processing or can deliver the hydrocarbon to a processing facility for processing. Typically flowing with the hydrocarbon is produced water.

Tapped off of the production line 150 is a scaling tendency monitor 170. The scaling tendency monitor 170 is configured to provide a real-time scaling tendency for the production piping, which includes the production tubing 130 and the production line 150. The scaling tendency monitor 170 includes conduit 172, a stresser 174, an analyzer 176, and a controller 178, all which are located within an enclosure 179. The enclosure 179 can support the components located therein and also protect the components from the environment.

The conduit 172 is connected to the production line 150 via tap line 154. Tap line 154 is connected to the production line via valve 156 and connected to the conduit 172 at the enclosure 179. Mechanical connectors, for example, conventional connectors used in the industry, can be used for the connections. The conduit 172 receives a portion of the produced water flowing through the production line 150, i.e., tapped produced water, via the tap line 154. Other equipment can be used with the tap line 154 to deliver the tapped produced water to the scaling tendency monitor 170. For example, additional valves including a throttle valve, strainers, filters, and a pump can be used with the tap line 154. A water separator 155 is shown as an example of other equipment that can be used with the tap line 154. The water separator 155 can be a simple separator, such as gravity separator. A bypass valve can also be associated with the tap line 154 to bypass the scaling tendency monitor 170.

The stresser 174 is configured to apply one or more scaling stress to the tapped produced water flowing through the conduit 172. As noted above the scaling stress can be heat, chemical, or both heat and chemical stresses can be used by the stresser 174.

The analyzer 176 is fluidly coupled to the stresser 174 via the conduit 172. The analyzer 176 is configured to determine a scaling tendency of the tapped produced water after application of the one or more scaling stresses from the stresser 174. After application of heat stress, the analyzer 176 acquires and records parameters from the tapped produced water that are necessary to perform heat transfer analysis. As deposits (scale in this case) accumulate, a surface of the conduit 172, or heat exchanger surface, becomes thermally insulated, and a change in Heat Transfer Resistance (HTR) is electronically recorded. The analyzer 176 can also use the HTR change to determine at what surface temperatures or flow rates the tapped produced water will start to scale. Most scales have inverse solubility, allowing the tapped heated produced water to be in higher scaling tendency conditions than the actual produced water that is downhole in the wellbore 101, or in the production line 150. Since the tapped produced water can be heat stressed closer to the scaling conditions of the main produced water, the analyzer 176 can detect increased scaling tendency before scaling occurs in the wellbore 101 and provide an early warning. The amount of early warning detected by the analyzer 176 can be adjusted by the amount of heat stress added by the stresser 174.

The analyzer 176 can also provide an early warning of scaling when a chemical stresser is applied. For example, for scale types with solubility that increases with temperature, such as barium sulfate, adding heat stress to the tapped produced water most likely would not result in scaling of the conduit 172. Accordingly, a chemical stress can be injected into the tapped produced water by the stresser 174. The chemical stress can be a scalant, such as sulfate. With the chemical stress, the analyzer 176 can determine scaling based on scaling particles in the tapped produced water. For example, the analyzer 176 can monitor for turbidity as the tapped produced water flows through the conduit. The monitoring can be continuous and in real time. The turbidity will increase due to the precipitation of scale in the tapped produced water due to the increased chemical stress applied by stresser 174, such as from an increased concentration of scale reactants. This technique also provide an early warning that the scaling tendency has increased enough in the tapped produced water, to cause scale particles, but the main produced water has not yet reached the scaling point. As with the heat stress, the amount of early warning can be adjusted by the amount of additional stress (scalant) injected before determining the presence of scaling particles in the tapped produced water after stressing.

The controller 178 is communicatively coupled to the stresser 174 and the analyzer 176 and is configured to direct operation of the scaling tendency monitor 170. For example, the controller 178 can be used to monitor and control the flow of the tapped produced water through the conduit 172. The controller 178 can control the flow by adjusting a valve, such as valve 156, and/or a pump to control flow rates of the tapped produced water through the tap line 154. The controller 178 includes one or more processors, data storage (such as one or more memory), and at least one communications interface that is configured for internal communication and external communication. For example, the one or more processors can send instructions for operating the stresser 174 and the analyzer 176 via a communications interface. A data output can also be provided and sent to the well site controller 160 via a communications interface. A wireless or hardwire connection can be used for communicating with the well site controller 160. The data output can be automatically generated and sent and can include a scaling warning and instructions for applying an antiscalant to the wellbore 101 based on the scaling tendency determined by the analyzer 176. Instructions for applying the antiscalant can also be sent directly to the inhibitor metering pumps 144. The scaling tendency monitor 200 of FIG. 2 provides an example of the scaling tendency monitor 170.

FIG. 2 illustrates a block diagram of an example of a scaling tendency monitor 200 constructed according to the principles of the disclosure. The scaling tendency monitor 170 is configured to provide a real-time scaling tendency that can be used to prevent or at least reduce scaling in production piping. The scaling tendency monitor 200 includes conduit 210 that receives tapped produced water, such as from a production line. The conduit 210 carries the tapped produced water through a stresser 220 and an analyzer 230. The tapped produced water is then discharged out of the scaling tendency monitor 200 via the conduit 210. The tapped produced water can be discharged into a holding tank for later processing.

The stresser 220 includes a heat exchanger 224 and/or a chemical injector 228. The heat exchanger 224 varies a temperature applied to the conduit 210 and the tapped produced water flowing therethrough. The chemical injector 228 injects a scalant into the tapped produced water flowing through the conduit 210. The heat exchanger 224 and the chemical injector 228 can be conventional devices used to vary the temperature and inject chemicals. Controller 240 is communicatively coupled to the heat exchanger 224 and the chemical injector 228 and directs the operations thereof. For example, the controller 240 can instruct the amount of temperature change to the heat exchanger 224 and the amount of scalant to inject to the chemical injector 228. The instructions can be automatically provided based on, for example, analysis provided by analyzer 230. The instruction can be based on tuning of the stress applied.

The analyzer 230 is configured to detect a scaling tendency of the tapped produced water after application of the one or more scaling stresses from the heat exchanger 224 or the chemical injector 228. For a heat stress, the analyzer 230 includes a heat analyzer 234 that determines the presence of scaling using heat analysis. For example, the heat analyzer 234 can calculate the heat transfer resistance (HTR) based on data obtained from the heat exchanger 224. When scaling occurs, the scale insulates the surface of the heat exchanger 224, which can be the surface of the conduit 210, and heat increases. The presence and/or amount of scaling can be provided to the controller 240 for further processing. The heat analyzer 234 can determine scaling based on HTR calculations using measurements from the heat exchanger 224. The heat analyzer 234 can use different HTR equations for the calculations. The equation used can depend on the type of measurements that are obtained by the heat exchanger 224. Equation 1 provides an example of an equation that the heat analyzer 234 can use for HTR calculations.

HTRₜₒₜₐₗ=A (T_{block}−T_{water})/HEAT Equation 1

where: HTRₜₒₜₐₗ=Total Heat Transfer Resistance (hr-ft²-° F./Btu, [m²-° C./Watt]), Area=Tube outside surface area of the conduit 210 (ft², [m²]), T_{block}=Heater block temperature (° F., [° C.]), and T_{water}=Water temperature (° F., [° C.]), Heat=Heat applied (Btu/hr, [Watts]).

For chemical stress, the analyzer 230 includes a scale particle detector 238 that detects scale particles in the water. The scale particles may not be sticking to the surface of the conduit but can still be present. The amount of scale particles detected can be provided to the controller 240 for further processing. The scale particle detector 238 can be a turbidity detector that measures the turbidity of the tapped produced water flowing through the conduit 210. As such, the scale particle detector 238 can be an inline turbidity instrument. A collection point, such as a wide spot in the conduit, can be used to collect water and the presence of scale particles can be detected in the collected water.

The analyzer 230 is communicatively coupled to controller 240 and indicates a scaling tendency (or change of scaling tendency) based on the heat analyzer 234 or the scale particle detector 238. The controller 178 can automatically generate a data output that provides a warning signal of scaling or scaling tendency change, and can also change a dosage of antiscalant that is added to a wellbore. A portion of the logic of the heat analyzer 234 and/or the scale particle detector 238 can be located on the controller 240.

FIG. 3 illustrates a flow diagram of an example of a method 300 of monitoring a change in scaling tendency for a well carried out according to the principles of the disclosure. The method 300 can be used to determine changes in scaling tendency at the surface in real time to prevent scaling downhole. A scaling tendency monitor such as disclosed herein, for example scaling tendency monitors 170 or 200, can be used to detect the change in scaling tendency. The method 300 can continually monitor for scaling tendency changes during operation of the well. The method 300 begins in step 305.

In step 310, tapped produced water is received. The tapped produced water can be received via a tap line from a production line such as shown in FIG. 1. The tap line can include a water separator. The tapped produced water can be received by a scaling tendency monitor via the tap line, such as scaling tendency monitor 170 via tap line 154.

In step 320, an amount of scaling stress added to the tapped produced water is tuned. Tuning includes adjusting the amount of stress by determining an amount of stress that causes scaling of the tapped produced water and then reducing the amount of stress. The stress can be, for example, heat that is added via a heat exchanger or a scalant that is added via a chemical injector. Once the amount of stress causing scaling has been determined, the amount of stress can be reduced, for example, by five to ten percent. The amount of stress causing scaling and the amount of reducing can vary for different wells. Additionally, the amount of reduction can vary based on, for example, a desired response time to prevent downhole scaling or an acceptable risk level for downhole scaling. As such, the amount of stress can be tuned for each specific well. The type of stress that is applied, such as heat or scalant, can also vary depending on the well. FIG. 2 provides an example of a stresser that can be used for tuning. A controller and a stresser, such as controller 240 and stresser 220, can be used in cooperation to maintain the reduced amount of stress during monitoring.

The tapped produced water is stressed in step 330. The tapped produced water can be stressed while flowing through a conduit, such as conduit 210 of FIG. 2. The reduced amount of stress determined in step 320, whether heat or chemical, can be used for applying the stress during monitoring. Depending on the type of stress applicable for a well, a heat exchanger or a chemical injector, such as heat exchanger 224 and chemical injector 228, can be used to apply the type of stress needed.

In step 340, a change in scaling tendency of the tapped produced water is determined after application of the stress. The stress can be the reduced amount of stress and the change in scaling tendency is based on detecting scaling from the tapped produced water after application of the reduced amount of stress. A heat analyzer, such as heat analyzer 234, or a scale particle detector, such as scale particle detector 238, can be used to monitor for scaling in order to determined changes in scaling tendency. The change in scaling tendency can be an increase or a decrease.

A data output is generated and transmitted in step 350 when a change in scaling tendency is determined. The data output can be automatically sent in response to a change in scaling tendency and before actual downhole scaling occurs. The data output can be one or more alerts warning of scaling that is manually reviewed and can be acted upon. The data output can be an instruction to automatically increase the amount of anti-scalant in the well in real time as fluid flows uphole through the scaling tendency monitor and scaling is detected therein. The amount of anti-scalant can be based on different factors, such as historical data for a well, the amount or percentage of reduced stress, and the number of times a change in scaling tendency has occurred within a particular amount of time. The data output can include actual scaling values and be used to reduce the amount of anti-scalant to a normal operating level after an increase based on a scaling tendency change. A controller, such as controller 240 can generate and transmit the data output.

In step 360, an amount of anti-scalant added to the well can be changed based on the data output. The amount of anti-scalant can be automatically changed or can be manually changed. Inhibitor metering pumps or another controller for applying anti-scalant can be operated to change the amount of anti-scalant applied. The method continues to step 370 and ends.

FIG. 4 illustrates a block diagram of an example of a controller 400 of a scaling tendency monitor constructed according to the principles of the disclosure. Controller 400 is configured to direct the operation of a scaling tendency monitor, such as scaling tendency monitor 170 or 200, which includes performing the various functions disclosed herein. For example, the controller 400 is operable to generate and send data output based on scaling tendency changes detected by the scaling tendency monitor. The data output can include recommendations of amount of anti-scalant to add to a well. Controller 400 is also configured to communicate operating data with components of a scaling tendency monitor, such as a stresser and an analyzer. The operating data includes operating instructions sent to the stresser and analyzer and measurement information received from the stresser and the analyzer. The measurement information can indicate the presence of scaling from the analyzer. Controller 400 includes a communications interface 410, one or more memory 420, and one or more processor 430. Controller 400 can be implemented on a computing device, such as a laptop or a computing pad. The various components of controller 400 can communicate via wireless or wired conventional connections.

Communications interface 410 is configured to transmit and receive data. For example, communications interface 410 can receive operating data from a stresser and an analyzer and provide the received operating data to the processor 430. Communications interface 410 can transmit, for example, a scaling alert, scaling status, and/or instructions for adding a scaling inhibitor downhole as determined by the processor 430 based on at least some of the operating data. Communications interface 410 can communicate via communication protocols and systems used in the industry and includes the necessary circuitry, software, or combination thereof for communicating data. Wireless or wired protocols can be used. Communications interface 410 can include more one than type of communications circuitry for the different types of communication.

Memory 420 can be configured to store a series of operating instructions that direct the operation of processor 430 when initiated, including the code representing the algorithms for heat analysis and particle analysis. Memory 420 is a non-transitory computer readable medium. Multiple types of memory can be used for data storage and memory 420 can be distributed.

Processor 430 can be configured to produce data output using the measurement from stresser and analyzer. For example, processor 430 can perform a heat analysis from the collected measurements using one or more algorithms and generate a scaling alert. Processor 430 can be configured to direct the operation of the controller 400. Processor 430 includes the logic to communicate with communications interface 410 and memory 420, and perform the functions described herein.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter. Configured or configured to means, for example, designed, constructed, or programmed, with the necessary logic and/or features for performing a task or tasks.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A scaling tendency monitor, comprising:
conduit;
a stresser configured to apply at least one type of scaling stress to tapped produced water flowing through the conduit; and
an analyzer configured to determine a change in scaling tendency of the tapped produced water after application of the one or more scaling stress.

2. The scaling tendency monitor as recited in claim 1, wherein the scaling stress is heat.

3. The scaling tendency monitor as recited in claim 1, wherein the scaling stress is a chemical.

4. The scaling tendency monitor as recited in claim 1, wherein the stresser applies two different types of stress wherein one type is heat and the other type is a chemical.

5. The scaling tendency monitor as recited in claim 1, wherein the tapped produced water is water that is diverted from produced water, and the at least one type of scaling stress is selected based on a scaling history of the produced water.

6. The scaling tendency monitor as recited in claim 1, wherein the analyzer determines the scaling tendency based on heat transfer analysis.

7. The scaling tendency monitor as recited in claim 1, wherein the analyzer determines the scaling tendency based on scale particles within the tapped produced water.

8. The scaling tendency monitor as recited in claim 7, wherein the analyzer includes a turbidity detector that detects the scale particles within the tapped produced water.

9. The scaling tendency monitor as recited in claim 1, further comprising a controller that directs operation of the scaling tendency monitor and generates a data output indicating the scaling tendency change.

10. The scaling tendency monitor as recited in claim 9, wherein the controller automatically generates the data output, which includes an instruction for automatically increasing a dosage of antiscalant based on the scaling tendency change.

11. The scaling tendency monitor as recited in claim 9, wherein the controller automatically generates the data output, which includes a scaling alert based on the scaling tendency change.

12. The scaling tendency monitor as recited in claim 9, wherein the controller automatically generates the data output, which includes a value of the scaling tendency.

13. A method of monitoring a change in scaling tendency for a wellbore, comprising:
receiving a tapped produced water;
stressing, while flowing through a conduit, the tapped produced water; and
determining a change in scaling tendency of the tapped produced water after the stressing.

14. The method as recited in claim 13, further comprising tuning an amount of stress applied to the tapped produced water for the stressing.

15. The method as recited in claim 13, wherein the stressing includes applying heat to the tapped produced water.

16. The method as recited in claim 13, wherein the stressing includes injecting a scalant into the tapped produced water.

17. The method as recited in claim 13, further comprising automatically sending an alert indicating a scaling tendency change when determining a change in the scaling tendency.

18. The method as recited in claim 13, further comprising automatically initiating a change in an amount of anti-scalant added to the wellbore.

19. The method as recited in claim 13, wherein the receiving, stressing, and determining are carried out in real time.

20. A scaling tendency monitoring system for a well, comprising:
a tap line connected to a production line associated with the well; and
a scaling tendency monitor, including:
conduit connected to the tap line;
a stresser configured to apply at least one type of scaling stress to tapped produced water flowing through the tap line and the conduit; and
an analyzer configured determine a scaling tendency of the tapped produced water after application of the one or more scaling stress.
